(19) United States
(12) Patent Application Publication
(10) Pub. No.: US 2025/0154051 A1
(43) Pub. Date: May 15, 2025

(54) GLASS ARTICLE

(71) Applicant: AGC Inc., Tokyo (JP)

(72) Inventors: Hiroki FUJIMOTO, Tokyo (JP); Yasushi Kawamoto, Tokyo (JP); Yuukou Minamiya, Tokyo (JP)

(73) Assignee: AGC Inc., Tokyo (JP)

(21) Appl. No.: 19/021,143

(22) Filed: Jan. 14, 2025

Related U.S. Application Data
(63) Continuation of application No. PCT/JP2023/027748, filed on Jul. 28, 2023.

(30) Foreign Application Priority Data
Aug. 2, 2022 (JP) 2022-123521

(51) Int. Cl. C03C 17/34; B60J 3/00; B60J 3/06

(52) U.S. Cl. CPC C03C 17/3417; B60J 3/007; B60J 3/06; C03C 2217/212; C03C 2217/213; C03C 2217/231; C03C 2217/948; C03C 2218/119; C03C 2218/154

(57) ABSTRACT

A glass article in which delamination and whitening of each layer provided on a glass substrate can be suppressed even after being used for a long period of time after heating and molding performed at a high temperature, and of which the adhesiveness between layers and the appearance are both excellent is provided. A glass article includes, on a glass substrate, a coating film and a shielding layer in this order, in which a porosity at an interface between the coating film and the shielding layer is 24% or lower. A Bi/Si ratio in the shielding layer is preferably 3.9 or higher. The coating film is preferably a dry coating film. The glass article can be used as a window glass for automobile.

### INCORPORATION BY REFERENCE

This application is based upon and claims the benefit of priority from Japanese Patent Application 2022-123521 filed on Aug. 2, 2022, and PCT application No. PCT/JP2023/27748 filed on Jul. 28, 2023, the disclosure of which is incorporated herein in its entirety by reference.

### BACKGROUND

The present disclosure relates to a glass article, and in particular, a glass article for vehicle.

In glass articles, such as window glasses for vehicles and those for buildings, desired characteristics are imparted to them by coating the surfaces of their glass substrates with various materials according to their uses.

International Patent Publication No. WO2021/107707 discloses a glass article in which a low emissivity coating film and a shielding layer in which a black pigment, glass frit, and the like are added are provided on its substrate. In general, a shielding layer is provided on the peripheral edge of a glass article for vehicle (e.g., a window glass for automobile), and is provided in order to prevent an adhesive used therein from deteriorating due to sunlight and improve its design or the like.

### SUMMARY

When a glass article having the structure disclosed in Patent Literature 1 is molded at a high temperature (e.g., 600° C. or higher) according to its desired use, the following phenomena occur in some cases. That is, there are cases in which each layer (e.g., a shielding layer) provided on a glass substrate is peeled off, and there are cases in which the surface of the glass article appears whitish (whitening) due to the influence of voids that are formed during the heating and molding process, so that the appearance of the glass article deteriorates. Further, there are cases in which even though the delamination of a layer is not observed in the glass article immediately after the heating and molding performed at a high temperature, the delamination of a layer occurs during repeated use thereof over a long period of time.

The present disclosure has been made in view of the above-described problem, and an object thereof is to provide a glass article in which delamination and whitening of each layer provided on a glass substrate can be suppressed even after being used for a long period of time after heating and molding performed at a high temperature, and of which the adhesiveness between layers and the appearance are both excellent.

A glass article according to the present disclosure comprises, on a glass substrate, a coating film and a shielding layer in this order, wherein
a porosity at an interface between the coating film and the shielding layer is 24% or lower.

In the glass article, a maximum length among all voids at the interface between the coating film and the shielding layer may be 2.5 μm or shorter.

In any of the above-described glass articles, a Bi/Si ratio in the shielding layer may be 3.9 or higher.

In any of the above-described glass articles, the Bi/Si ratio in the shielding layer may be 4.7 or higher.

In any of the above-described glass articles, a melting start temperature of a crystal component of which the shielding layer is formed may be 600° C. or higher.

In any of the above-described glass articles, the coating film may be a dry coating film.

In any of the above-described glass articles, the dry coating film may be a film selected from among a heat-ray reflection coating film, a low-emissivity coating film, a low-reflection coating film, and a p-polarization reflection coating film.

In any of the above-described glass articles, voids formed above the glass substrate may be more concentrated at the interface between the coating film and the shielding layer than at other parts.

In any of the above-described glass articles, voids formed above the glass substrate may have non-uniform shapes.

In any of the above-described glass articles, cross-sectional shapes of voids when the glass article is cut perpendicularly to the glass substrate may be oblate shapes, polygonal shapes, or irregular shapes.

Any of the above-described glass articles may be used as a window glass for automobile.

According to the present disclosure, it is possible to provide a glass article in which delamination and whitening of each layer provided on a glass substrate can be suppressed even after being used for a long period of time after heating and molding performed at a high temperature, and of which the adhesiveness between layers and the appearance are both excellent.

The above and other objects, features and advantages of the present disclosure will become more fully understood from the detailed description given hereinbelow and the accompanying drawings.

### BRIEF DESCRIPTION OF DRAWINGS

FIG. 1A is a schematic cross-sectional diagram of an embodiment of a glass article according to the present disclosure;

FIG. 1B is a schematic plan view of the embodiment of the glass article according to the present disclosure;

FIG. 2 is an example of a cross-sectional SEM image of a glass article according to the present disclosure manufactured in Example 3; and

FIG. 3 is an example of a cross-sectional SEM image of a glass article manufactured in Example 8.

### DESCRIPTION OF EMBODIMENTS

In the specification of the present disclosure, a symbol “-” which indicates a range of numerical values, means that values in front of and behind this symbol are included in the range as lower and upper limit values, respectively.

In numerical ranges described in a stepwise manner in the present specification, the upper or lower limit value of one numerical range may be replaced with the upper or lower limit value of another numerical range described in a stepwise manner. Further, in numerical ranges described in a stepwise manner in the present specification, the upper or lower limit value of a numerical range may be replaced with values shown in Examples.

As described above, when a glass article having the structure disclosed in Patent Literature 1 is heated and molded at a high temperature, an interface between layers provided on a glass substrate, e.g., an interface between a coating film and a shielding layer, may be peeled off, or whitening may occur on the surface of the glass article due to voids generated during the molding process. Further, even when the delamination of a layer is not observed immediately after the heating and molding, the delamination of a layer may occur after a certain period of time.

The inventors of the present disclosure have speculated that such delamination and whitening that occur due to the heating and molding operations (and a subsequent optional cooling operation) or during the use of the glass article are due to the following causes. That is, in the process for forming a coating film, a gas contained in the coating film is degassed during the heating and remains at the interface between the coating film and the shielding layer, so that voids are eventually formed. The inventors have therefore speculated that the adhesion of the interface deteriorates due to the generated voids, causing the delamination of a layer. Further, light is scattered by the generated voids, so that a phenomenon (whitening) occurs in which when the glass article is observed from the surface on the side on which the shielding layer is not disposed, the glass article appears whitish.

As a result of intense study, the inventors of the present disclosure have found that the occurrence of delamination of a layer and whitening during the heating and molding or after a certain period of time can be suppressed by adjusting the porosity at the interface between the coating film and the shielding layer to a specific range.

Embodiments of glass articles according to the present disclosure (hereinafter, also simply referred to as “the present glass article”) will be described hereinafter in detail with reference to the drawings, but the present disclosure is not limited to these embodiments. Further, the present disclosure may be modified as desired without departing from the scope and spirit of the disclosure.

### <Glass Article>

A glass article according to the present disclosure can be suitably used as a glass for vehicle such as automotive, especially as a window glass for automobile, and can be used at a position on any part of the body of the vehicle, including the front, rear, side, and ceiling thereof. Further, a glass article according to the present disclosure can also be used for uses other than uses in vehicles, e.g., for buildings and the like without limitation. Further, it is sufficient if a glass article according to the present disclosure has any of the structures described below in at least a part thereof. For example, the glass article may be used as a single-sheet glass including only one glass substrate, or as a laminated glass including a plurality of glass substrates. The method for manufacturing a glass article according to the present disclosure is not limited to any particular methods. For example, a glass article can be manufactured by a known float method as will be described later.

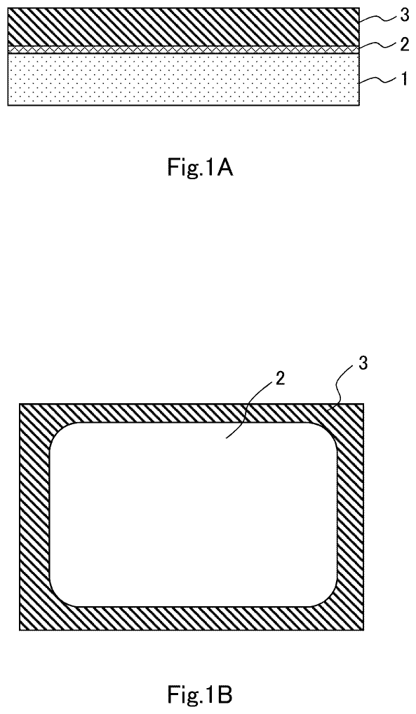

As shown in FIG. 1A, a glass article according to the present disclosure includes, on a glass substrate 1, a coating film 2 and a shielding layer 3 in this order. As described above, it is sufficient if these layers are successively laminated on at least a part of one of the surfaces of the glass substrate. That is, these layers may or may not be laminated over the entire surface of the glass substrate of which the glass article is formed. For example, the coating film 2 may be provided over the entire surface of the glass substrate, and as shown in FIG. 1B, the frame-like shielding layer 3 may be provided, on the coating film 2, in a part which becomes the peripheral edge of the glass substrate. Further, other layers may be provided between these layers as long as the effects of the present disclosure are obtained. For example, a color tone adjustment layer for adjusting the color tone, a heat insulating film layer, a UV-cut film layer, and the like may be provided. However, in view of the delamination prevention property and the whitening prevention property, a glass article according to the present disclosure is preferably composed of a glass substrate 1, a coating film 2, and a shielding layer 3. Note that FIGS. 1A and 1B are schematic diagrams of an embodiment of a glass article according to the present disclosure. In particular, FIG. 1A is a schematic cross-sectional diagram of an embodiment of a glass article according to the present disclosure, and FIG. 1B is a schematic plan view thereof when viewed from the side on which the shielding layer 3 is located.

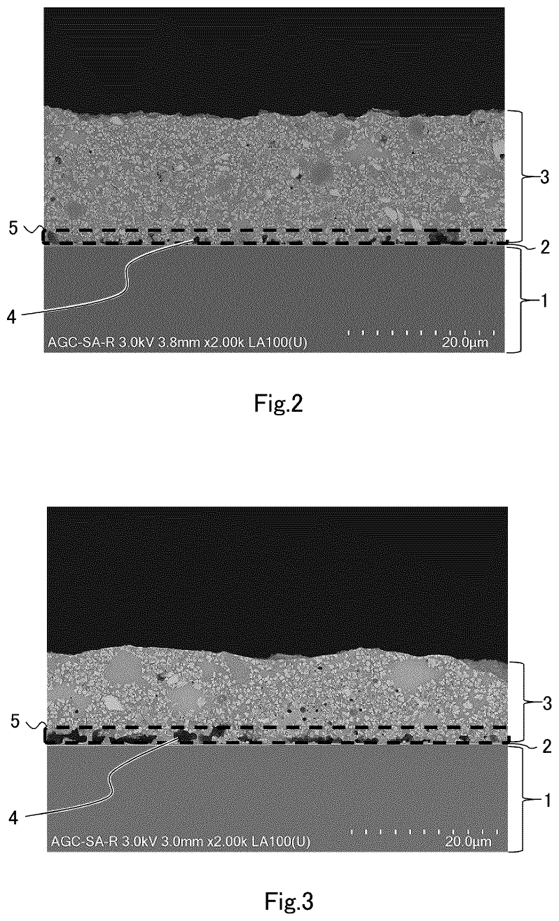

As shown in FIG. 2, in the present glass article, the presence ratio of voids 4 (i.e., porosity) in the interface 5 between the coating film 2 and the shielding layer 3 is 24% or lower. When the porosity is 24% or lower, the adhesion between layers after the heating and molding (hereinafter, also referred to as initial adhesion) and the adhesion after the glass article is used for a certain period of time (also referred to as long-term adhesion) are both excellent, and the whitening of the glass article can be suppressed. Further, in view of the initial adhesion and long-term adhesion, the porosity is preferably 22% or lower, more preferably 15% or lower, and still more preferably 10% or lower. Further, the porosity at the above-described interface is preferably 0.5% or higher. When the porosity is 0.5% or higher, light is scattered by microscopic voids present at the interface, and the absorption of solar radiation energy in the shielding layer part decreases as compared with the case where such voids do not exist, so that the rise in temperature of the glass can be easily suppressed. As a result, the risk of a burn which would otherwise be caused when a driver or the like touches the glass article can be further reduced, and the comfortability in the vehicle can be further improved. Further, in view of the above-described properties or the like, the porosity at the above-described interface is more preferably 1.0% or higher. Note that FIG. 2 is an example of a cross-sectional SEM image of a glass article according to the present disclosure manufactured in Example 3 (which will be described later).

The range of the interface 5 between the coating film 2 and the shielding layer 3 in which the porosity is measured can be set as appropriate according to the thicknesses of the coating film and the shielding layer as long as the range is near the interface between the coating film 2 and the shielding layer 3. In this embodiment, the porosity is measured by setting the above-described interface 5 to a range of thickness of 2.5 μm from the surface of the coating film 2 toward the shielding layer. Note that a specific method for measuring a porosity will be described later.

A glass article having a specific porosity according to the present disclosure has an excellent delamination prevention property and an excellent whitening prevention property and has excellent adhesion between the coating film and the shielding layer, in which it is possible to suppress the occurrence of the delamination of a layer and whitening which would otherwise be caused by voids, so that the glass article can have an excellent appearance. Therefore, even when the present glass article is molded into a curved shape at a high temperature (e.g., 600 to 750° C.) for use in a vehicle, it is easy to prevent the occurrence of delamination of a layer and whitening in the glass substrate.

Note that the maximum length among all voids 4 at the interface 5 between the coating film and the shielding layer is preferably 2.5 μm or shorter. When the maximum length among all voids is 2.5 μm or shorter, the initial adhesion and long-term adhesion are both excellent. Further, in view of the above-described properties or the like, the maximum length among all voids is more preferably 1.5 μm or shorter. Further, the maximum length among all voids is preferably 0.3 μm or longer. When the maximum length among all voids is 0.3 μm or longer, light is scattered by microscopic voids present at the interface, and the absorption of solar radiation energy in the shielding layer part decreases as compared with the case where such voids do not exist, so that the rise in temperature of the glass can be easily suppressed. As a result, the risk of a burn which would otherwise be caused when a driver or the like touches the glass article can be further reduced, and the comfortability in the vehicle can be further improved. Further, in view of the above-described properties or the like, the maximum length among all voids is more preferably 0.5 μm or longer. A specific method for measuring the maximum length among all voids will be described later.

The above-described porosity and the maximum length among all voids at the interface can be adjusted, for example, by changing the manufacturing conditions of the coating film (e.g., the mixture/type of process gases), the elemental composition of the shielding layer, the type of frit contained in the shielding layer, the firing (baking) conditions (e.g., heating rate), and the like.

As shown in FIG. 2, in a glass article according to the present disclosure, voids 4 formed above the glass substrate 1 are more concentrated at the interface 5 between the coating film and the shielding layer (i.e., a part having a thickness of 2.5 μm from the surface of the coating film toward the shielding layer) than at other parts of the glass article. Specifically, preferably 30% or more, more preferably 50% or more, and still more preferably 70% or more of voids formed above the glass substrate are concentrated at the above-described interface between the coating film and the shielding layer. It is considered that this phenomenon occurs for the following reasons. That is, when the coating film (e.g., a dry coating film) is formed, a gas (e.g., a process gas in dry coating: an inert gas such as Ar) trapped in the coating film is degassed from the coating film during the heating and molding performed at a high temperature. Then, when the material for forming the shielding layer (hereinafter also referred to as a shielding layer forming material) is melted by the heating and molding, the aforementioned gas remains in the vicinity of the interface between the coating film and the shielding layer, so that voids are eventually formed there.

Note that the presence ratio (presence percentage) of the above-described voids at the interface can be calculated from cross-sectional SEM images of arbitrarily-selected three points used in the measurement of a porosity and the maximum length among all voids (which will be described later), and the average value of these presence ratios of voids obtained from the three points is used as the presence ratio of voids at the interface.

Note that as shown in FIG. 2, a large number of voids 4 may be formed above the glass substrate of the glass article according to the present disclosure, and these voids may have non-uniform shapes. Specifically, the cross-sectional shapes of voids 4 when the glass article is cut perpendicularly to the glass substrate 1 may be various shapes such as oblate shapes, polygonal shapes, or irregular shapes. Note that the irregular shape is not a regular shape such as a circular shape, an elliptical shape, and a polygonal shape, but is an irregular and distorted shape. As described above, the shapes of voids formed above the glass substrate are not limited to any particular shapes, and may be distorted shapes. That is, it is sufficient if the above-described porosity is within a specific range.

### [Glass Substrate]

Regarding the glass substrate (glass plate), known glass substrates can be used as appropriate. For example, a heat ray absorbing glass, a clear glass, a soda lime glass, a quartz glass, a borosilicate glass, an alkali-free glass, a green glass, or a UV green glass can be used. However, when a glass article according to the present disclosure is used as a glass for vehicle, the glass substrate is required to have a visible-light transmittance conforming to the safety standards of the country in which the vehicle is used. Further, when the glass article is used for other purposes, the glass substrate is required to have characteristics required for those purposes. Therefore, the composition of the glass substrate is preferably adjusted so as to achieve the required characteristics. As the composition of the glass substrate, for example, the below-shown composition can be used, in which the components are shown by mass % based on the oxide. Note that the composition of the glass substrate can be specified by an X-ray fluorescence analysis.
Silica (SiO₂): 70 to 73 mass %,
Alumina (Al₂O₃): 0.6 to 2.4 mass %,
Lime (CaO): 7 to 12 mass %,
Magnesia (MgO): 1.0 to 4.5 mass %,
R₂O: 13 to 15 mass % (R represents an alkali metal such as Na or K), and
Total iron oxide (T-Fe₂O₃) in terms of Fe₂O₃: 0 to 1.5 mass %.

Note that the glass substrate may be substantially transparent, or may be tinted, i.e., colored. Further, a glass substrate that has been subjected to a strengthening process can be used as required. The strengthening process may be a chemical strengthening process or a physical strengthening process (air-cooled strengthening process).

Further, the shape of the glass substrate is not limited to any particular shapes as long as it can be molded to a shape suitable for the desired purpose. For example, the glass substrate may have a rectangular shape. The shape of a glass article according to the present disclosure is, for example, a curved shape, and the curved shape is not limited to any particular curved shapes. For example, the glass article may have such a shape that it is curved in the up/down direction on the paper on which FIG. 1A is shown. Note that the glass article according to the present disclosure includes those in which a glass substrate in which a coating film and a shielding layer are provided has not yet been formed and those in which the glass substrate has been formed into a desired shape. Therefore, the glass substrate included in the present glass article may be, for example, a rectangular glass substrate that has not been molded yet or a glass substrate that has already been molded and has a curved shape. Note that a glass article according to the present disclosure may be formed by, for example, forming a curved surface in a glass substrate by a heating bending process called firing bending when the shielding layer is fired. Further, a glass article according to the present disclosure may be formed by forming a shielding layer and the like on a glass substrate, and then separately performing firing bending, or may be formed by forming a shielding layer and the like, performing temporary firing, and then performing firing bending. As described above, the timing of the molding of a glass article according to the present disclosure can be selected as desired.

The thickness of the glass substrate may be set according to the purpose and is not limited to any particular values. For example, when the glass substrate is used for an automobile among various types of vehicles, the thickness of the glass substrate is, for example, 0.2 to 5.0 mm and preferably 0.3 to 3.0 mm.

In the case of a laminated glass, in particular, a laminated glass used for a windshield or a roof glass of an automobile, and is located on the outer side of the vehicle when it is attached to the automobile, the thickness of the glass substrate is preferably 1.1 mm or larger and more preferably 1.8 mm or larger in view of the strength such the tolerance to stone chips. Further, in order to reduce the weight of the laminated glass, the thickness of the glass substrate is preferably 3.0 mm or smaller and more preferably 2.8 mm or smaller. In the case of a laminated glass that is disposed on the inner side of the vehicle when it is attached to the automobile, the thickness of the glass substrate is preferably 0.3 mm or larger in view of the handling ability, and is preferably 2.3 mm or smaller in order to reduce the weight of the laminated glass. Further, the glass article can be suitably used not only as a single-sheet glass but also as a laminated glass. That is, the glass article can be used for various uses. Note that the thickness of two glass substrates used for a laminated glass may be equal to each other or different from each other.

The glass substrate can be manufactured as appropriate by a known method (e.g., a float method, a fusion method, and a rollout method), and the method for manufacturing a glass substrate is not limited to any particular methods. Note that a commercially available product may be used as the glass substrate.

### [Coating Film]

In the glass article according to the present disclosure, the coating film 2 is disposed between the glass substrate 1 and the shielding layer 3. The method for laminating a coating film on a glass substrate is not limited to any particular method. However, in order to make better use of the excellent effects of the present disclosure, the coating film according to this embodiment is preferably a dry coating film using dry coating in which a thin film is formed in a vacuum by using a vapor growth method.

The dry coating includes physical vapor deposition (PVD: Physical Vapor Deposition), which is a physical film formation method including vacuum deposition and sputtering, and chemical vapor deposition (CVD: Chemical Vapor Deposition), which is a chemical film formation method.

The PVD method is a method in which a film forming material of which a thin film is eventually formed is vaporized and scattered into a state of particles (atoms and molecules) by heating, sputtering, ion beam irradiation, laser irradiation, or the like, mainly in a state of high vacuum (10⁻¹ to 10⁻⁵ Pa), and then the vaporized and scattered material is made to adhere to and deposited on the surface of the substrate.

The vacuum deposition is a technology in which a thin film is formed by heating, melting, vaporizing or sublimating a film forming material such as a metal or a metal oxide in a vacuum, and then making vaporized or sublimated particles (atoms and molecules) adhere to and deposit on the surface of the substrate.

Further, the sputtering is a technology in which a thin film is formed by feeding an inert gas (mainly, Ar) in a vacuum, applying a negative voltage to a target (e.g., a plate-like film forming material) and thereby generating a glow discharge, ionizing inert gas atoms, making gas ions violently collide and hit against the surface of the target at a high speed, making particles (atoms and molecules) of the film forming material of which the target is formed to be ejected therefrom, and making the ejected particles adhere to and deposit on the surface of the substrate with great force. In the sputtering method, a film can be formed even with a material with which it is difficult to form a film by the vacuum deposition method, such as a metal or an alloy having a high melting point, so that a wide range of film forming materials can be used.

Meanwhile, the CVD method is a method in which: a gaseous raw material is fed in a state where the pressure is between the atmospheric pressure and a medium vacuum (100 to 10⁻¹ Pa); a chemical reaction is excited and accelerated by supplying energy such as heat, plasma, and light, and a thin film or fine particles are thereby synthesized; and the thin film or fine particles are made to adhere to and deposited on the surface of the substrate.

Among them, in order to make better use of the excellent effects of the present disclosure, it is preferred to use, as a dry coating film, a film selected from among a heat-ray reflection coating film, a low-emissivity coating film (Low-E film), a low-reflection coating film, and a p-polarization reflection coating film. As methods for forming these films, known methods can be used as appropriate.

The heat-ray reflection coating film can be formed of one or more layers and, for example, can be formed of a plurality of layers (e.g., 10 to 18 layers). Specifically, the heat-ray reflection coating film can include a dielectric layer, a functional layer, and a barrier layer. For example, the heat-ray reflection coating film may be formed of a first dielectric layer, a functional layer, a barrier layer, and a second dielectric layer laminated in this order from the glass substrate side.

Note that the functional layer may be formed of any one of Ag, Au, Cu, Al and Pt, or a combination thereof. Among them, the functional layer may preferably be formed of any one of Au, Cu, Al and Pt, or a combination thereof. Each of the dielectric layer and the barrier layer may be formed of any one of Ti, Zn, Sn, Si, Al and Ni, or a combination thereof. Note that each of the dielectric layer and the barrier layer may be formed of an oxide, nitride, or oxynitride of these elements.

The low-emissivity coating film may be formed of one or more layers and, for example, can be formed of a plurality of layers (e.g., two to six layers). Specifically, the low-emissivity coating film may include a dielectric layer and a functional layer. Note that each of the dielectric layer and the functional layer may be formed of one layer or a plurality of layers. For example, the low-emissivity coating film may be formed of a first dielectric layer, a functional layer, and a second dielectric layer laminated in this order from the glass substrate side. Further, in this structure, each of the first dielectric layer, the functional layer, and the second dielectric layer may be formed of one layer or a plurality of layers. Note that the functional layer can be formed of any one of In, Sn, Al, Ni, Cr and F, or a combination thereof.

Note that the functional layer may be formed of an oxide, nitride, or oxynitride of these elements.

The dielectric layer can be formed of any one of Si, C, Ti, Zr, Nb and Al, or a combination thereof. Note that the dielectric layer may be formed of an oxide, nitride, or oxynitride of these elements.

The low-reflection coating film can be formed of one or more layers and, for example, can be formed of a plurality of layers (e.g., two layers). For example, the low-reflection coating film can be formed of a high-refraction layer and a low-refraction layer laminated in this order from the glass substrate side. Note that the low-refraction layer can be formed of Si, and the high-refraction layer can be formed of Ti. Each of these refraction layers may be formed of an oxide, nitride, or oxynitride of these elements.

The p-polarization reflection coating film can be formed of one or more layers and, for example, can be formed of a plurality of layers (e.g., two layers). For example, the p-polarization reflection coating film can be formed of a high refraction layer and a low refraction layer laminated in this order from the glass substrate side. Each of these layers can be formed of any one of Au, Ag, Cu, Si, Al, Zn, Zr, Sn, Nb, Ni, In, Ce, W, Mo, Sb, Bi and Ti, or a combination thereof. Note that the p-polarization reflection coating film may be formed of an oxide, nitride, or oxynitride of these elements.

The components (elements) of which the coating film is formed are not limited to any particular components. As described above, the components can be formed of, for example, Ag, Au, Cu, Pt, Ni, F, C, In, Sn, Ti, Nb, Ta, Zn, Al, In, Si, Cr, B and Zr, or can be formed of a nitride, oxide, or oxynitride of these elements. Further, a plurality of types of these components can be combined with one another. The composition of the coating film can be specified by using energy dispersive X-ray spectroscopy (SEM-EDX). The acceleration voltage in the aforementioned method can be set as appropriate, but in order to perform more accurate measurement, it is preferably 5 to 25 keV and more preferably 15 to 20 keV.

Further, in the glass article according to the present disclosure, it is sufficient if the coating film is provided on at least a part of one of the surfaces of the glass substrate. Therefore, the coating film may be in contact with the glass substrate. Alternatively, another layer may be provided between the glass substrate and the coating film, so that the glass substrate and the coating film may not be directly in contact with each other.

Although the thickness of the coating film is not limited to any particular values, the total thickness is preferably 25 to 500 nm, more preferably 50 to 450 nm, and still more preferably 100 to 400 nm in order to achieve various excellent properties.

### [Shielding Layer]

The shielding layer may be provided on at least a part of one of the surfaces of the glass substrate, more specifically, on at least a part of the coating film. However, when the present glass article is used as a glass article for vehicle, the shielding layer is preferably provided so as to cover the peripheral edge of the glass substrate. The shielding layer prevents the components or the like for mounting the glass article on the body of the vehicle and the terminals of electric components from being visible from the outside of the vehicle.

Note that the shielding layer may have various shapes such as a frame shape, a band shape, and a dot shape. In FIG. 1B, the frame-like shielding layer 3 is provided on the peripheral edge of the glass substrate, more specifically, on the peripheral edge of the coating film 2. Note that the shielding layer may be provided, for example, so as to cover a specific area extending from the edge of the glass substrate. More specifically, the shielding layer may cover a part at least within 30 mm from the edge (e.g., within 50 mm of the edge) of the glass substrate.

The shielding layer includes a crystal component, and may further include a pigment, an additive (e.g., resin), and the like. As the shielding layer, a layer of which the melting start temperature (melting point) of the crystal component is high is preferably used in order to diffuse (degas) the gas remaining at the interface between the coating film and the shielding layer and thereby suppress the generation of voids during the heating and molding. Specifically, the melting start temperature of the crystal component is preferably 600° C. or higher. When the aforementioned temperature is 600° C. or higher, the viscosity at a high temperature is low, so that the diffusion of the gas remaining at the interface between the coating film and the shielding layer can be activated, e.g., accelerated. As a result, it is possible to easily prevent voids from being formed. Therefore, it is possible to easily prevent the occurrence of whitening in which the surface of the glass article appears whitish because light scatters in voids. Further, it is possible to prevent the adhesion at the interface from deteriorating, which would otherwise be caused by voids, by suppressing the formation of voids, and it is also possible to prevent the delamination of layers, which would otherwise be caused by the difference between the linear expansion coefficient of the coating film and that of the shielding layer.

Further, in order to suppress the formation of voids and prevent whitening, the resin decomposition (combustion) completion temperature of the shielding layer is preferably low. Specifically, the resin decomposition (combustion) completion temperature is preferably 400° C. or lower.

The components (elements) of which the shielding layer is formed are not limited to any particular components. For example, the components may include the following elements: Si, Bi, O, Fe, Ni, C, B, Al, Li, Na, K, Mg, Ca, Ba, Sr, Zn, Ti, Ce, Zr, Cu, Cr, Mn and Co.

In order to prevent the formation of voids and the occurrence of whitening, it is preferred to adjust the composition of the shielding layer. Specifically, it is preferred to adjust the composition ratio of Si (silicon), which has a function of raising the aforementioned melting start temperature, and Bi (bismuth), which has a function of lowering the aforementioned melting start temperature, i.e., the Bi/Si ratio (mass % ratio) of the shielding layer to 3.9 or higher. When the Bi/Si ratio is 3.9 or higher, the degassing of the gas which forms voids is accelerated and the porosity is reduced, so that the whitening of the surface of the glass article can be suppressed. Further, in view of the above-described properties or the like, the Bi/Si ratio is more preferably 4.4 or higher, still more preferably 4.7 or higher, still more preferably 5.2 or higher, and particularly preferably 6.3 or higher.

Further, the composition of the shielding layer can be specified by using energy dispersive X-ray spectroscopy (SEM-EDX). The acceleration voltage in the aforementioned method can be set as appropriate, but in order to perform more accurate measurement, it is preferably 5 to 25 keV and more preferably 15 to 20 keV.

The shielding layer (e.g., a black ceramic layer) is a fired layer which can be formed by coating a shielding layer forming material (ceramic paste) on a desired place (e.g., on the peripheral edge) in the glass substrate, more specifically, in a desired place on the coating film, heating the applied shielding layer forming material at a high temperature, and thereby sintering the applied shielding layer forming material. The firing temperature can be set as appropriate. For example, the firing temperature can be set to 500 to 700° C. (more specifically, 600° C. or higher).

The shielding layer forming material which has not been fired yet can include frit (corresponding to the crystal component when the shielding layer is formed), a pigment (e.g., a heat-resistant black pigment), and, if necessary, additives such as an (organic) vehicle for dispersing the pigment, a conductive metal, a reducing agent, a dispersive surfactant, a fluid-type modifier, a fluid-type auxiliary agent, an adhesion promoter, a stabilizer, and a colorant. Note that a commercially available product can also be used as the shielding layer forming material. By forming the shielding layer as a fired layer, the shielding layer is bonded to the glass substrate.

The aforementioned frit can contain, for example, one or more type(s) of component(s) such as SiO₂, Bi₂O₃, Cr₂O₃, Cs₂O, Na₂O, B₂O₃, ZnO, TiO₂, La₂O₃, Nb₂O₅, MnO₂, CeO₂, MoO₃, WO₃, F, Al₂O₃, BaO, MgO, CaO and K₂O. Note that it is known that frit having a high melting point range has excellent chemical resistance and a relatively low thermal expansion coefficient.

SiO₂ in the frit forms a glass network and is also a crystallized component. Further, it also controls chemical, thermal, and mechanical characteristics of the frit, and has a property of increasing the melting point of the frit. SiO₂ may be contained not only in the form of SiO₂, but also in the form of a composite such as Bi₄Si₃O₁₂. In order to improve the whitening prevention property, the content of SiO₂ in the shielding layer is preferably 10 mass % or more, and more preferably 13 mass % or more. Further, in order to maintain the sintering property, the content of SiO₂ in the shielding layer is preferably 30 mass % or less, and more preferably 28 mass % or less.

Meanwhile, Bi₂O₃ in the frit is a component for forming a glass network and has a property of lowering the melting point. In order to improve the whitening prevention property, the content of Bi₂O₃ in the shielding layer is preferably 60 mass % or less, and more preferably 55 mass % or less. Further, in view of the fluidity, the content of Bi₂O₃ in the shielding layer is preferably 40 mass % or more, and more preferably 43 mass % or more.

When the shielding layer is formed, the frit may or may not have a crystal form different from that before the firing, i.e., the crystal form at the raw material stage (shielding layer forming material). Further, the crystal component in the shielding layer may be formed of one type of frit or may be formed of a plurality of types of frits which are, for example, fused by firing.

Further, the frit may be manufactured by a known method. For example, frit having a desired composition can be manufactured by mixing starting materials according to a desired composition, melting the mixture at a desired temperature for a desired time, and, if necessary, cooling the molten mixture by using water or the like. If necessary, the frit can be pulverized into a desired particle size (e.g., 1 to 8 μm) by a known pulverization technique. Note that a commercially available product may also be used as the frit.

The content of the frit in the shielding layer forming material can be set as appropriate, but in order to obtain satisfactory sintering property, it is preferably 60 mass % or more, more preferably 65 mass % or more, and still more preferably 70 mass % or more. On the other hand, in order to maintain the glass strength, the content of the frit in the shielding layer forming material is preferably 99 mass % or less, more preferably 98 mass % or less, and still more preferably 96 mass % or less.

Note that the content in the shielding layer forming material in the specification of the present application means that the content in the total amount of inorganic components among the components constituting the shielding layer forming material. That is, the contents of organic components are not taken into account. Therefore, the content of the frit in the shielding layer forming material is the amount that is obtained by excluding the contents of filler and the like in the shielding layer forming material.

As the aforementioned pigment, known pigments can be used as appropriate. For example, pigments derived from one or more type(s) of composite inorganic pigment(s) such as corundum-hematite, olivine, priderite, pyrochlore, rutile, spinel, and the like can be used. As the pigment, for example, a metal oxide pigment (spinel pigment) containing copper (Cu), chromium (Cr), iron (Fe), cobalt (Co), nickel (Ni), manganese (Mn), aluminum (Al), magnesium (Mg), zinc (Zn), zirconium (Zr), niobium (Nb), yttrium (Y), tungsten (W), antimony (Sb), calcium (Ca), or the like can be used. These black spinel pigments can be suitably used in the automotive industry, and other metal oxide pigments that produce other colors can be used as appropriate as pigments in other industries such as the construction industry, the household appliance industry, and the beverage industry.

Note that the spinel structure is a common pigment structure having a general formula AB₂X₄, where X is typically O²⁻ or F⁻ having substantially the same ionic radius. Note that A and B represent a tetrahedral site and an octahedral site, respectively, in an ordinary spinel lattice. The spinel structure can be formed from a number of different elements, including transition elements in Group 1, and hence serves as the structure for many inorganic pigments. Most spinel compounds have a cubic space group, but a distorted spinel structure can have a tetragonal phase and, in some cases, can have an orthorhombic phase.

More specific examples of metal oxide pigments include CuO·CrO₃, CuCr₂O₄, (Co, Fe)(Fe, Cr)₂O₄, MnCr₂O₄, NiMnCrFe, CuCrMnO, and those obtained by modifying these pigments by using modifying agents. Note that properties of a pigment can be determined by the raw material, the synthesis technique and conditions, the post-firing process, and the like. A pigment may be synthesized by a known method, e.g., a method disclosed in Published Japanese Translation of PCT International Publication for Patent Application, No. 2019-509959, or a commercially available product may be used.

A desired pigment may be formed, for example, by chemically combining minute metal oxides or salts containing the target metal, and calcining them. When doing so, the size of the minute metal oxide can be set as appropriate, and is preferably 1 nm to 10 μm, more preferably 10 nm to 1 μm, and still more preferably 50 to 500 nm.

Further, as the pigment, one derived from a rare earth manganese oxide pigment can be used. For example, (YxMn)Oy, (LaxMn)Oy, (CexMn)Oy, (PrxMn)Oy, or (NdxMn)Oy can be used. Note that in the above-shown chemical formula, x is preferably 0.01 to 99, more preferably 0.08 to 12, and still more preferably 0.25 to 4. Further, in the above-shown chemical formula, y represents the number of oxygen atoms required to maintain the electrical neutrality, and is preferably x+1 to 2x+2. Specific examples of pigments include CeMnO₃, PrMnO₃, NdMnO₃, and pigments obtained by modifying these pigments by using a modifying agent. Note that the rare earth manganese oxide pigment preferably has a perovskite crystal structure or an orthorhombic crystal structure. By using a rare earth manganese oxide pigment, a high infrared reflectance can be achieved, and the heat generation characteristic can be lowered. Further, no cobalt material is contained in the pigment, and even if it is dissolved in an acidic solution such as acid rain, it does not generate and elute hexavalent chromium.

The content of the pigment in the shielding layer forming material can be set as appropriate, but in order to obtain a desired color tone, the content of the pigment in the shielding layer forming material is preferably 0.1 mass % or more, more preferably 1 mass % or more, still more preferably 2 mass % or more, and particularly preferably 5 mass % or more. Further, in order to maintain the sintering property of the shielding layer, the content of the pigment is preferably 50 mass % or less, more preferably 30 mass % or less, still more preferably 25 mass % or less, and particularly preferably 15 mass % or less.

Examples of organic vehicles for dispersing and suspending the above-described frit and pigment include vegetable oils, mineral oils, low molecular-weight petroleum distillates, tridecyl alcohol, synthetic resins, and natural resins.

As the conductive metal, for example, silver (silver particles) can be used.

As the reducing agent, for example, silicon metal can be used.

When an inert particulate inorganic pigment is used, the dispersive surfactant has a function for assisting the pigment in getting wet. In general, the dispersive surfactant contains a block copolymer including a group having an affinity for the pigment, and if necessary, contains a solvent (e.g., xylene, butyl acetate, methoxypropyl acetate). As the dispersive surfactant, known ones can be used. For example, Disperbyk 162 (product name, manufactured by BykChemie) can be used.

The fluid-type modifier is used to adjust the viscosity, and any conventionally known ones can be used as appropriate. For example, Viscobyk series (manufactured by BykChemie) can be used.

The fluid-type auxiliary agent is an additive used to adjust viscosity and flowability, and any conventionally known ones can be used. For example, Additol VXW6388 (product name, manufactured by UCB Surface Speciality) can be used.

The adhesion promoter is used to improve compatibility with the layer (coating film) on which the shielding layer is provided, and can be selected as appropriate according to the composition of the used coating film.

As the stabilizer, for example, a light stabilizer or a UV shielding agent can be used.

Note that the amounts of these additives to be mixed can be set as appropriate and are not limited to any particular values.

The composition of the shielding layer (the entire shielding layer including the frit, the pigment, the additive, and the like) may be, for example, the below-shown composition, in which the components are shown by mass % based on the oxide. Note that the composition of the shielding layer may be considered to be the same as that of the shielding layer forming material which has not been fired yet.
Bi₂O₃: 40 to 60 mass %,
SiO₂: 15 to 30 mass %,
Cr₂O₃: 5 to 25 mass %,
CuO: 3 to 8 mass %,
MnO₂: 3 to 6 mass %,
Al₂O₃: 0.2 to 4 mass %,
MgO: 0 to 2 mass %,
CaO: 0 to 3 mass %,
BaO: 0 to 8 mass %
Na₂O: 0 to 5 mass %,
K₂O: 0 to 3 mass %,
TiO₂: 0 to 5 mass %, and
ZnO: 0 to 8 mass %.

The thickness of the shielding layer affects the ultraviolet transmittance, the acid resistance, the weatherability, the concealability, the glass strength, and the cost. In view of the ultraviolet transmittance, the acid resistance, the weatherability, and the concealability, the thickness of the shielding layer is preferably 5 μm or larger, more preferably 8 μm or larger, and still more preferably 10 μm or larger. Further, in view of the glass strength and the cost, the thickness of the shielding layer is preferably 30 μm or smaller, more preferably 20 μm or smaller, and still more preferably 15 μm or smaller. The thickness of the shielding layer can be specified by using a scanning electron microscope (SEM).

The firing conditions of the shielding layer can be set as appropriate within a range in which the effects of the present invention can be obtained, i.e., within a range in which the above-described porosity is 24% or lower. For example, the firing speed (conveyance speed) (mm/s) and the firing temperature (° C.) when the object to be processed (to which the shielding layer forming material is provided) is conveyed in an automobile glass molding process can be adjusted. Further, when the firing temperature is changed during the firing, the temperature profile thereof and the like can be adjusted. For example, the firing time can be set to 3 to 30 minutes (preferably 4 to 20 minutes), and the firing temperature can be set to 550 to 730° C. (preferably 580 to 710° C., and more preferably 600 to 710° C.).

### <Method of Manufacturing Glass Article>

The method for manufacturing a glass article according to the present disclosure is not limited to any particular methods. For example, a glass article according to the present disclosure can be manufactured by a manufacturing method including the following steps.
A step of preparing a glass substrate (substrate preparation step).
A step of forming a coating film on the glass substrate (coating film forming step).
A step of forming a shielding layer on the coating film (shielding layer forming step).

The substrate preparation step (substrate manufacturing step) may include a step of melting a glass raw material and pouring the molten material into a tin bath (melting step), and a step of slowly cooling the molten glass raw material (slow cooling step).

The shielding layer forming step may include, for example, the following steps.
A step of preparing a shielding layer forming material (shielding layer forming material preparing step).
A step of applying the shielding layer forming material onto a coating film (coating step).
A step of sintering the shielding layer forming material applied onto the coating film (sintering step).

Further, the above-described manufacturing method may include the following steps.
A step of heating and molding the glass substrate on which the coating film and the shielding layer are provided in this order into a desired shape (heating and molding step).
A step of cooling the heated and molded glass substrate (cooling step).

These steps may be successively performed, or a plurality of steps (e.g., the shielding layer forming step (specifically, the sintering step) and the hating and molding step) may be performed in parallel to each other.

The above-described manufacturing method will be described hereinafter in detail.

Firstly, for example, a rectangular glass substrate (glass plate) is prepared (substrate preparation step). In this process, a commercially available glass substrate may be purchased and used. Alternatively, a glass substrate can be manufactured by, for example, the following method. That is, glass raw materials mixed to obtain a desired glass composition is heated at a predetermined temperature, and molten glass is thereby obtained. Next, the obtained molten glass is poured into a tin bath filled with molten tin (melting step), and a plate-like glass ribbon is molded and slowly cooled (a slow cooling step), so that a glass substrate is obtained. In this process, the obtained glass ribbon may be subjected to additional processes (e.g., SO₂ treatment and cleaning process). Note that the glass substrate can be molded in any of the above-described melting step and the slow cooling step. Further, when a glass substrate is manufactured, it can be cut into a desired size. For example, when a glass for vehicle is used as a windshield for automobile, a glass substrate having a size of (500 to 1,300 mm)×(1,200 to 1,700 mm)×(1.6 to 2.5 mm) is prepared. The glass substrate may consist of one sheet or may be a laminated glass in which two or more glass sheets are bonded to one another.

Next, a coating film is formed on at least a part of one of the surfaces of the glass substrate, for example, over the entire area of one of the surfaces of the glass substrate (coating film forming step). The conditions for forming a coating film can be selected as appropriate according to the type of the coating film to be manufactured. For example, when a low-emissivity coating film (Low-E film) is formed as the coating film, it is formed by sputtering by using one of an Ar gas, an O₂ gas, and an N₂ gas, or a mixture gas thereof as the process gas.

Next, a frame-like shielding layer is formed on at least a part of the coating film, for example, on the peripheral edge of the coating film (shielding layer forming step). Specifically, the shielding layer forming material (e.g., ceramic color paste) is applied to at least a part of the area of the glass substrate where the coating film has been formed (coating step), and if necessary, the applied shielding layer forming material is dried. The method for applying a shielding layer forming material is not limited to any particular methods. For example, a screen-printing method, an ink jet method, electronic printing, or the like can be used. Specifically, it is preferred to print a shielding layer forming material on the glass substrate with a #150 to #250 mesh screen.

Note that for the shielding layer forming material, a commercially available product may be used, or the shielding layer forming material may be separately prepared (shielding layer forming material preparation step). The shielding layer forming material can be prepared, for example, by dispersing the above-described desired frit and pigment in an organic vehicle.

Next, the obtained glass substrate is heated to a predetermined temperature by using, for example, a firing furnace such as an IR furnace, and the shielding layer forming material is thereby sintered on the glass substrate (sintering step). The heating (firing) temperature is not limited to any particular temperatures. For example, the heating temperature is 500 to 730° C. (preferably 550 to 700° C.). Further, the firing speed (conveyance speed) is also not limited to any particular speeds, and is preferably 5 to 30 mm/s. Further, the heating time is, for example, 3 to 30 minutes (preferably 4 to 20 minutes). Through the above-described processes, a shielding layer is formed on the glass substrate.

Note that since the glass frit contained in the shielding layer forming material exhibits various characteristics, one type of frit may be used or two or more type(s) of frit(s) may be used in a mixed manner. Further, two or more type(s) of frit(s) that have the same composition but have different particle sizes may be used as appropriate in a mixed manner. The melting point of the frit is preferably 600° C. or higher and more preferably 630° C. or higher in order to reduce the porosity. Further, the melting point of the frit is preferably 700° C. or lower and more preferably 680° C. or lower in view of the adhesion to the glass.

When two or more type(s) of frit(s) are used in a mixed manner, it is preferred that among them, one or more type(s) of frit(s) have a softening point within the above-described range, and it is more preferred that all the frits have a softening point within the above-described range.

Next, the glass substrate on which the coating film and the shielding layer are provided in this order is heated and molded into a desired shape (heating and molding step), and if necessary, a cooling operation is performed (cooling step). Note that the glass substrate may be molded into a desired shape by performing self-weight bending or press bending in a state where the glass substrate is held at the heating temperature in the above-described sintering step. That is, the heating and molding step and the sintering step may be performed in parallel to each other.

In the press bending, for example, the glass plate is bent by a press apparatus (heating press apparatus) according to the desired shape of the window glass for automobile. In the self-weight bending, the glass substrate is bent by a self-weight bending apparatus. Further, air-cooling strengthening or the like may be performed according to the safety standards required for the window glass for automobile.

The present glass article obtained as described above has excellent durability, in which it is possible to suppress the occurrence of the delamination of a layer and whitening in the glass substrate, so that the glass article has an excellent appearance. Further, the present glass article does not use any whisker-like refractory material, and can achieve both the low-temperature sintering property of the shielding layer forming material and the high plate strength of the glass article.

### EXAMPLES

The present disclosure will be described hereinafter in a more detailed manner by using a plurality of examples, but the present disclosure is not limited to these examples. Note that Examples 1 to 7 are examples for glass articles according to the present disclosure, and Examples 8 to 10 are comparative examples. Further, FIGS. 2 and 3 show partial cross-sectional SEM images of glass articles manufactured in Examples 3 and 8, respectively.

### Example 1

### (Example 1-1) Preparation of Glass Substrate and Manufacturing of Coating Film

A low-emissivity coating film was formed on one of the surfaces of a glass substrate by using a sputtering apparatus. Specifically, first, a glass substrate having a thickness of 2.1 mm (product name: FGY1, manufactured by AGC Inc.) was prepared. Next, a titanium oxide layer containing zirconia was formed on the surface of this glass substrate by a sputtering method. A zirconia-doped titania target in which the content of zirconia was 35 mass % was used for the film formation, and the target film thickness was 10 nm. Next, a silica layer was formed by a sputtering method. The target film thickness was 35 nm. Next, an ITO (Indium Tin Oxide) layer was formed by a sputtering method. The target film thickness was 120 nm. Next, a silica layer was formed. The target film thickness was 70 nm. Next, a silica layer containing zirconia was formed on the surface of the obtained glass substrate by a sputtering method. A zirconia-doped silica target in which the content of zirconia was 10 mass % was used for the film formation, and the target film thickness was 20 nm. Through the above-described steps, a glass substrate with a coating film was obtained. Note that Ar, O₂, or a mixed gas thereof was used for the film formation of each of the layers.

### (Example 1-2) Manufacturing of Shielding Layer

A shielding layer having an elemental composition (mass %) shown in Table 1 was manufactured on the above-described glass substrate, specifically, on the peripheral edge of the coating film. Specifically, a shielding layer forming material having the aforementioned elemental composition was printed on the peripheral edge of the coating film by a screen-printing method using a #150 to #250 mesh screen, and the printed shielding layer forming material was dried. Next, firing was performed by using a firing furnace (IR furnace) under the below-shown Firing Condition A, and the shielding layer forming material was thereby sintered on the glass substrate, so that a frame-like shielding layer as shown in FIG. 1B was formed. The thickness of the shielding layer was 15 μm. Through the above-described processes, the glass article including the coating film and the shielding layer laminated in this order was manufactured on the glass substrate.

### Firing Condition A

The temperature was raised at 3° C./sec until the temperature reached 630° C. Then, after the temperature reached 630° C., the firing temperature was maintained at 630° C. The total firing (heating) time was 240 seconds.

### Examples 2 to 10

In each of Examples 2 to 10, a glass article was manufactured in the same manner as in Example 1 except that the elemental composition (mass %) of the shielding layer was changed as shown in Table 1 and the firing condition was changed as shown in Table 2. Then, each of them was evaluated based on an evaluation method described later, and various physical property values were thereby measured. Note that the specific elemental composition (mass %) of the shielding layer described in Example 6 was as follows. Bi: 36.1, Si: 8.2, O: 29.1, Cr: 12.4, Cu: 5.5, Mn: 4, Na: 1.2, Al: 0.6, Ti: 0.4, K: 0.2, and C: 2.3 (total 100).

Further, details of the firing conditions shown in Table 2 are as follows.

### Firing Condition AA

The temperature was raised at 2° C./sec until the temperature reached 300° C. Then, after the temperature reached 300° C., the temperature was raised at 3.7° C./sec. Further, after the temperature reached 630° C., the firing temperature was maintained at 630° C. The total firing (heating) time was 240 seconds.

### Firing Condition B

The temperature was raised at 4.5° C./sec until the temperature reached 630° C. Then, after the temperature reached 630° C., the firing temperature was maintained at 630° C. The total firing (heating) time was 240 seconds.

### <Method for Measuring Physical Property Value>

The method for measuring physical property values of the obtained glass articles was as follows.

### [Porosity]

The porosity of the interface between the coating film and the shielding layer laminated on the glass substrate was measured based on the following method. That is, an image at a magnification of 2,000 times was acquired at each of randomly selected three points on a cut surface when the obtained glass article was cut perpendicularly to the surface of the glass substrate by using a scanning electron microscope (SEM) (product name: TM4000Plus, manufactured by Hitachi, Ltd.). Next, image processing was performed on each of the acquired cross-sectional SEM images at the three points by using commercially available image analysis software (product name: WinRooF 2018, manufactured by Mitani Corporation), and the ratio of pores (voids) which appear black was obtained based on the differences in contrast. Specifically, on the cross-sectional SEM image, the ratio of the total void cross-sectional area in the whole cross-sectional area in a range of a thickness of 2.5 μm from the interface between the coating film and the shielding layer toward the shielding layer and a width of 60 μm in an arbitrarily-selected part of the glass substrate was obtained. Then, the average value of the void ratios at the three points was obtained and used as the porosity (%). Table 2 shows the result of each of the examples.

Note that in Examples 1 to 10, 70% or more of the voids formed above the glass substrate were present at the above-described interface.

### [Maximum Pore Length]

In the measurement of the porosity described above, the length, in a direction parallel to the surface of the glass substrate, of each void present on the acquired cross-sectional SEM image at each of the three points was measured, and the length of the longest void was defined as the maximum void length (μm). Table 2 shows the result of each of the examples.

### [Composition of Shielding Layer]

The elemental composition of the shielding layer used in the glass article in each of the examples was specified by the following method. That is, the surface of the sample (shielding layer) was measured by energy dispersive X-ray spectroscopy (SEM-EDX), and the composition (mass %) of each component (element) was quantified. In the above-described process, Product name: TM4000Plus manufactured by Hitachi, Ltd. was used as a scanning electron microscope (SEM), and Product name: AZtecOne manufactured by Oxford Instruments was used as EDX. Table 1 shows the result of each of the examples.

### [Content of SiO₂]

The content of SiO₂ (mass %) in the shielding layer used for the glass article of each of examples was measured by SEM-EDX. Table 2 shows the result of each of examples.

### [Bi/Si Ratio]

The Bi/Si mass % ratio in the shielding layer of each of examples was calculated based on the above-described composition of the shielding layer specified by SEM-EDX. Table 2 shows the result of each of examples.

### <Evaluation Method>

The obtained glass articles were evaluated by the following evaluation method.

### [Evaluation of Initial Adhesion and Long-Term Adhesion]

The adhesion of the glass article manufactured in each of examples was evaluated by a method in conformity with the grid test (cross-cut test) specified in JIS K5400 (initial adhesion). Further, separately, the following operations were performed. That is, a series of operations in which a glass article was stored in a high-temperature environment (temperature: 80° C.) for 30 minutes and then stored in a low-temperature environment (temperature: −30° C.) for 30 minutes is defined as one cycle. Then, the glass article manufactured in each of examples was subjected to 100 cycles and 500 cycles (cooling and heating test). Then, the above-described grid test was performed on each of the glass articles subjected to the cooling and heating test in a manner similar (long-term adhesion). The results of the grid tests performed on the glass articles immediately after being manufactured and the grid tests performed on them after the cooling and heating test (100 cycles and 500 cycles as described above) were evaluated, i.e., categorized into six grades, i.e., into 10, 8, 6, 4, 2 and 0 points, based on the evaluation criteria specified in JIS K5400. Table 2 shows the evaluation results of each of the examples.

### [Evaluation of Melting Start Temperature of Crystal Component]

The melting start temperature of the crystal component (frit) used in the shielding layer used in each of Examples 1 and 8 was measured by increasing its temperature to 800° C. at a rate of 10° C./min by using a differential thermogravimetric analyzer (TG-DTA) (product name: Q650, manufactured by TA Instruments). As a result, the melting start temperature of the frit of Example 1 was 610° C. Further, as shown in Table 2, the porosity was low, and whitening did not occur. Meanwhile, the melting start temperature of the frit of Example 8 was 580° C. Further, as shown in Table 2, the porosity was high, and whitening occurred.

### [Evaluation of Whitening]

The degree of whitening of the glass article (especially the shielding layer part) of each of the examples was evaluated based on the following evaluation criteria. Table 2 shows the evaluation results.

### Evaluation Criterion

3: No voids are observed on the surface of the glass article under either a fluorescent light or a high-luminance LED hand light, and there is no part that appears whitish on the surface.
2: No voids are observed under a fluorescent light, but voids are observed on the surface of the glass article when a high-luminance LED hand light is used, and light is scattered at the voids and the surface appears whitish.
1: Voids are observed on the surface of the glass article even under a fluorescent light, and light is scattered at the voids and the surface appears whitish.

Note that an L* value, i.e., a luminosity index, in a CIE 1976 (L*a*b*) color space (CIELAB) for the color tone of the whitish part was measured according to JIS Z 8722 2000. CR-400 manufactured by Konica Minolta Inc. was used as a color colorimeter, and a CIE standard auxiliary illuminant light source C was used as a light source. Further, the measurement diameter was set to 8 mm. The L value on the surface of the glass article in Example 4 was 25, and the L value on the surface of the glass article in Example 7 was 24.

TABLE 1

| | Examples | Example | Examples | Example | Example | Example | Example | Example |
|---|---|---|---|---|---|---|---|---|
| Element | 1, 2 | 3 | 4, 8 | 5 | 6 | 7 | 9 | 10 |
| Bi | 40.8 | 37.3 | 39 | 40.2 | 36.1 | 38.3 | 29.6 | 50.8 |
| Si | 6.5 | 7.2 | 10.5 | 8.6 | 8.2 | 9.9 | 8.4 | 3.6 |
| Others | 52.7 | 55.5 | 50.5 | 51.2 | 55.7 | 51.8 | 62 | 45.6 |
| Total | 100 | 100 | 100 | 100 | 100 | 100 | 100 | 100 |

TABLE 2

| | | Maximum | | | | Evaluation results | | | |
|---|---|---|---|---|---|---|---|---|---|
| | | length | | Bi/Si | | | Adhesion | Adhesion | |
| | Porosity | of void | SiO₂ | (mass % | Firing | Initial | after 100 | after 500 | |
| | (%) | (μm) | content | ratio) | condisiton | Adhesion | cycles | cycles | Whitening |
| Example 1 | 0 | 0 | 15.9 | 6.3 | A | 10 | 10 | 10 | 3 |
| Example 2 | 10 | 1.7 | 15.9 | 6.3 | B | 10 | 10 | 10 | 3 |
| Example 3 | 15 | 2.5 | 17.2 | 5.2 | AA | 10 | 10 | 10 | 3 |
| Example 4 | 20 | 1.5 | 25.1 | 3.7 | A | 10 | 10 | 10 | 2 |
| Example 5 | 22 | 6.0 | 20.9 | 4.7 | B | 8 | 6 | 6 | 2 |
| Example 6 | 24 | 2.5 | 19.2 | 4.4 | A | 10 | 8 | 6 | 2 |
| Example 7 | 24 | 2.5 | 23.6 | 3.9 | A | 10 | 8 | 6 | 2 |
| Example 8 | 25 | 6.0 | 25.1 | 3.7 | B | 8 | 6 | 2 | 1 |
| Example 9 | 30 | 2.0 | 20.3 | 3.5 | B | 10 | 6 | 2 | 1 |
| Example 10 | 60 | >20 | 8.7 | 14.1 | B | 10 | 6 | 2 | 1 |

From the results described above, it is understood that a glass article having a specific porosity according to the present disclosure has an excellent delamination prevention property and an excellent whitening prevention property and has excellent adhesion between the coating film and the shielding layer, in which it is possible to suppress the occurrence of the delamination of a layer and whitening which would otherwise be caused by voids, so that the glass article has an excellent appearance.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A glass article comprising, on a glass substrate, a coating film and a shielding layer in this order, wherein
a porosity at an interface between the coating film and the shielding layer is 24% or lower.

2. The glass article according to claim 1, wherein a maximum length among all voids at the interface between the coating film and the shielding layer is 2.5 μm or shorter.

3. The glass article according to claim 1, wherein a Bi/Si ratio in the shielding layer is 3.9 or higher.

4. The glass article according to claim 2, wherein a Bi/Si ratio in the shielding layer is 3.9 or higher.

5. The glass article according to claim 3, wherein the Bi/Si ratio in the shielding layer is 4.7 or higher.

6. The glass article according to claim 3, wherein a melting start temperature of a crystal component of which the shielding layer is formed is 600° C. or higher.

7. The glass article according to claim 1, wherein the coating film is a dry coating film.

8. The glass article according to claim 7, wherein the dry coating film is a film selected from among a heat-ray reflection coating film, a low-emissivity coating film, a low-reflection coating film, and a p-polarization reflection coating film.

9. The glass article according to claim 7, wherein voids formed above the glass substrate are more concentrated at the interface between the coating film and the shielding layer than at other parts.

10. The glass article according to claim 7, wherein voids formed above the glass substrate have non-uniform shapes.

11. The glass article according to claim 10, wherein cross-sectional shapes of voids when the glass article is cut perpendicularly to the glass substrate are oblate shapes, polygonal shapes, or irregular shapes.

12. The glass article according to claim 1, used as a window glass for automobile.

13. The glass article according to claim 7, used as a window glass for automobile.
